(19) United States
(12) Patent Application Publication
(10) Pub. No.: US 2025/0363968 A1
(43) Pub. Date: Nov. 27, 2025

(54) KEYBOARD MUSICAL INSTRUMENT

(71) Applicant: YAMAHA CORPORATION, Hamamatsu-shi (JP)

(72) Inventor: Michiko TANOUE, Hamamatsu-shi (JP)

(21) Appl. No.: 19/287,194

(22) Filed: Jul. 31, 2025

Related U.S. Application Data
(63) Continuation of application No. PCT/JP2024/002195, filed on Jan. 25, 2024.

(30) Foreign Application Priority Data
Feb. 1, 2023 (JP) 2023-014150

(51) Int. Cl. G10F 5/00

(52) U.S. Cl. CPC G10F 5/00

(57) ABSTRACT

A keyboard musical instrument has a drive mechanism that includes a hammer shank displaceable in conjunction with a key operation; a restricting member that is struck by the hammer shank as a result of displacement of the hammer shank; a first support member that supports the restricting member; a first coil mounted to the drive mechanism; a wired board; a signal generator, including a second coil that generates a magnetic field, mounted to the wired board, the signal generator being configured to generate a detection signal based on a distance between the first coil and the second coil; a second support member configured to support the wired board; and a base member. The first support member and the second support member are fixed to the base member.

### CROSS REFERENCE TO RELATED APPLICATION

This application is a Continuation Application of PCT Application No. PCT/JP2024/002195, filed Jan. 25, 2024, and is based on and claims priority from Japanese Patent Application No. 2023-014150, filed Feb. 1, 2023, the entire contents of each of which are incorporated herein by reference.

### BACKGROUND OF THE INVENTION

### Field of the Invention

The present disclosure relates to keyboard musical instruments.

### Description of the Related Art

Various techniques have been proposed for detecting displacement of a movable member, such as a key of a keyboard musical instrument. International publication No. 2021/100448 discloses a keyboard musical instrument that generates a detection signal in accordance with a distance between a first coil mounted to a movable member and a second coil that generates a magnetic field.

To highly accurately detect displacement of the movable member, it is necessary to precisely set a positional relationship between the first coil and the second coil.

### SUMMARY OF THE INVENTION

In view of the above circumstances, an object of one aspect of the present disclosure is to highly precisely set the positional relationship between the first coil and the second coil.

In order to solve the above problem, a keyboard musical instrument according to an aspect of the present disclosure includes a drive mechanism including a hammer shank configured to be displaceable in conjunction with a key operation; a restricting member configured to be struck by the hammer shank as a result of displacement of the hammer shank; a first support member configured to support the restricting member; a first coil mounted to the drive mechanism; a wired board; a signal generator, including a second coil that generates a magnetic field, mounted to the wired board, the signal generator being configured to generate a detection signal based on a distance between the first coil and the second coil; a second support member configured to support the wired board; and a base member to which the first support member and the second support member are fixed.

### BRIEF DESCRIPTION OF THE DRAWINGS

FIG. 1 is a block diagram illustrating a configuration of a keyboard musical instrument according to a first embodiment.

FIG. 2 is a side view illustrating a configuration of a keyboard unit.

FIG. 3 is a perspective view of a rotation mechanism.

FIG. 4 is a block diagram illustrating a configuration of a detection system and of a control system.

FIG. 5 is a circuit diagram of a magnetic sensor.

FIG. 6 is a plan view of a drive board.

FIG. 7 is a plan view of a movable board.

FIG. 8 is a block diagram illustrating a configuration of a drive circuit.

FIG. 9 is an enlarged view of a holding member.

FIG. 10 is a cross-sectional view, taken along X-X line in FIG. 9.

FIG. 11 is a perspective view of a keyboard unit.

FIG. 12 is a perspective view of the keyboard unit.

FIG. 13 is a perspective view of a base member.

FIG. 14 is an enlarged side view of the base member and the second support member according to the second embodiment.

FIG. 15 is a plan view of an adjustment member.

FIG. 16 is an explanatory view of steps for installing the adjustment member.

FIG. 17 is a plan view of a drive board according to a third embodiment.

### DETAILED DESCRIPTION OF THE EMBODIMENTS

### A: First Embodiment

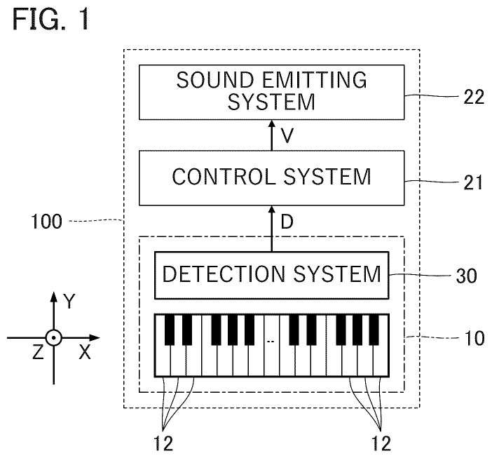

FIG. 1 is a block diagram illustrating a configuration of a keyboard musical instrument 100 according to a first embodiment of the present disclosure. The keyboard musical instrument 100 is an electronic musical instrument (specifically, an electronic piano) and includes a keyboard unit 10, a control system 21, and a sound emitting system 22.

In the following description, an X-axis, a Y-axis, and a Z-axis orthogonal to each other are assumed. The X-axis extends in the left-right direction (width direction) of the keyboard musical instrument 100. The Y-axis extends in the front-rear direction (depth direction) of the keyboard musical instrument 100. That is, an X-Y plane is parallel to the horizontal plane. The Z axis extends in the up-down direction (vertical direction) of the keyboard musical instrument 100. In the following description, an object viewed along the Z-axis is referred to as being in “plan view.”

The keyboard unit 10 includes a plurality of keys 12 and a detection system 30. The plurality of keys 12 includes a plurality of white keys and a plurality of black keys. Each of the plurality of keys 12 is a play operator, and each corresponds to a different music pitch. Each of the plurality of keys 12 is arranged along the X axis, and is elongate along the Y-axis, and is displaceable in accordance with an operation made by a user (hereinafter, a “key operation”). The key operation includes, for example, key depression, and key release.

The detection system 30 detects the key operation. The control system 21 generates an audio signal V in accordance with a detection made by the detection system 30. The audio signal V is a signal representative of a waveform of a music sound corresponding to the key operation. It is of note that the control system 21 may be configured separately from the keyboard musical instrument 100. For example, a general-purpose information processing apparatus such as a smartphone, a tablet terminal, or a personal computer may be used as the control system 21.

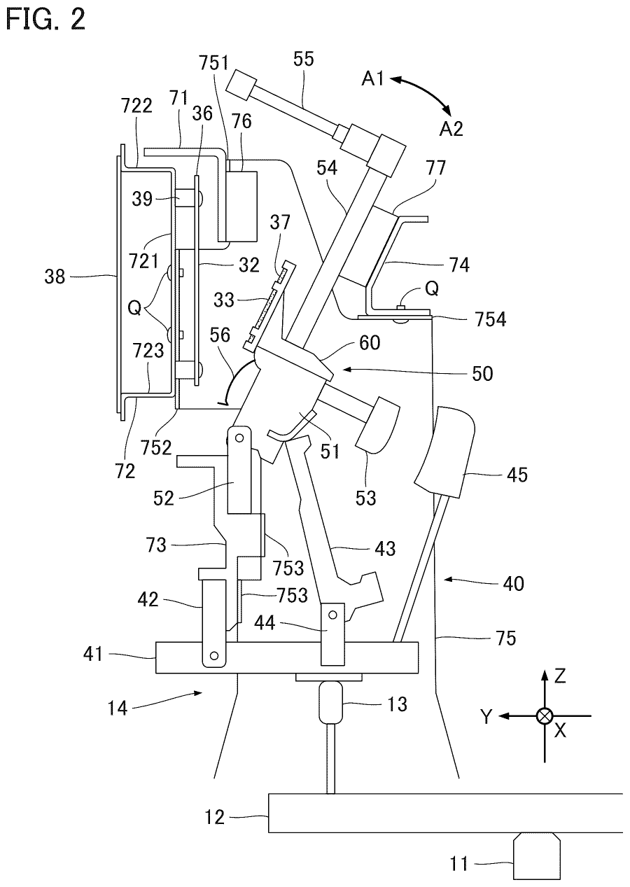

FIG. 2 is a side view illustrating a configuration of the keyboard unit 10, focusing on one of the plurality of keys 12. Each of the plurality of keys 12 of the keyboard unit 10 is supported by a balance pin 11. A front end portion of each of the plurality of keys 12 is displaceable in a vertical direction when depressed or released. A capstan 13 is provided at a back end portion of each of the plurality of keys 12.

The keyboard unit 10 according to the first embodiment includes a drive mechanism 14 for each of the plurality of keys 12. The drive mechanism 14 is an action mechanism that operates in response to the key operation. The drive mechanism 14 includes a transmission mechanism 40 and a rotation mechanism 50. The transmission mechanism 40 is a mechanism that transmits, in conjunction with the key operation, displacement of a respective one of the plurality of keys 12 to the rotation mechanism 50. In more detail, the transmission mechanism 40 includes a wippen 41, a wippen flange 42, a jack 43, a jack flange 44, and a back check 45. The wippen 41 is pivotally supported by the wippen flange 42. The jack flange 44 and the back check 45 are provided in the wippen 41. The jack 43 is pivotally supported by the jack flange 44. Each part of the transmission mechanism 40 is formed from, for example, wood, a resin material or a composite material. Examples of the composite material include a FRP or a CFRP, which is composed of a mixture of various types of fiber materials, and a composite material which is composed of a mixture of a plurality of types of materials (for example, materials such as wood, ceramics, and metals).

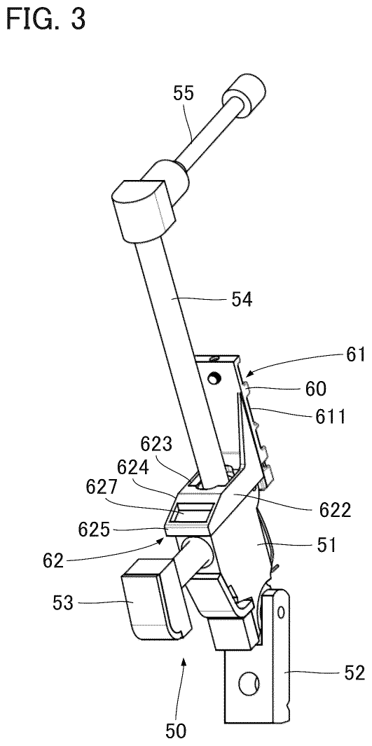

FIG. 3 is a perspective view of the rotation mechanism 50. As illustrated in FIGS. 2 and 3, the rotation mechanism 50 includes a butt 51, a butt flange 52, a catcher 53, a hammer shank 54, and a weight portion 55. The butt 51 is a structure supported by the butt flange 52. The hammer shank 54 is a columnar, elongate structure. A proximal end of the hammer shank 54 is fixed to the butt 51. The weight portion 55 is installed at a distal end of the hammer shank 54. The weight portion 55 is a metal counterweight that imparts to the user an appropriate weight-feel during key operation. The catcher 53 protrudes rearward from the butt 51. Each part of the rotation mechanism 50 other than the weight portion 55 is formed of, for example, wood, a resin material, or a composite material. Examples of the composite material include a FRP or a CFRP, which is composed of a mixture of various types of fiber materials, and a composite material which is composed of a mixture of a plurality of types of materials (for example, materials such as wood, ceramics, and metals).

According to the above configuration, when one of the plurality of keys 12 is depressed by the user, the back end of the depressed key 12 moves upward, causing the capstan 13 to press against and move upward the wippen 41. The upward movement of the wippen 41 causes the jack 43 to push the butt 51 upward, thereby causing the rotation mechanism 50 to rotate in a direction A1. After rotating in the direction A1, the rotation mechanism 50 rotates in a direction A2 under elastic force of the butt spring 56. The rotation of the rotation mechanism 50 halts when the catcher 53 comes into contact with the back check 45. As described above, the rotation mechanism 50 is displaced upon key operation by the user. The drive mechanism 14 of the first embodiment is a mechanism which, during key operation, imparts to the user a key feel of the keyboard musical instrument 100 that is close to a key feel of a acoustic keyboard musical instrument, although no actual string is struck. The butt 51 of the first embodiment is an example of a “movable member.”

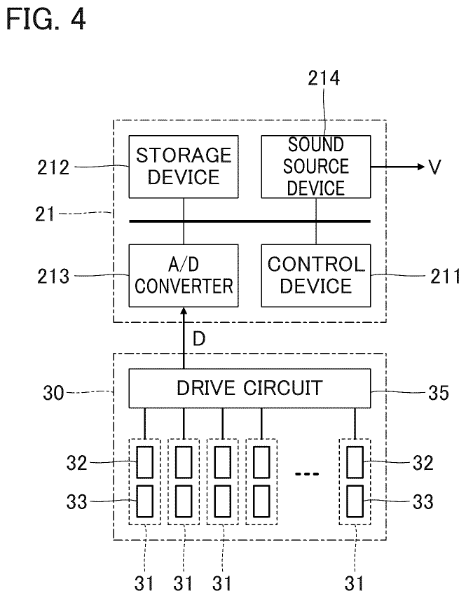

FIG. 4 is a block diagram illustrating configurations of a detection system 30 and a control system 21. The detection system 30 includes a plurality of magnetic sensors 31 corresponding to different drive mechanisms 14, and a drive circuit 35 that drives each of the plurality of magnetic sensors 31. A magnetic sensor 31 corresponding to a respective drive mechanism 14 is a sensor that detects a position of a hammer shank 54 of the respective drive mechanism 14. Each of the plurality of magnetic sensors 31 includes a signal generator 32 and a detectable portion 33. That is, a pair of the signal generator 32 and the detectable portion 33 is provided for each hammer shank 54.

As illustrated in FIG. 2, the detectable portion 33 is provided in the drive mechanism 14. Specifically, the detectable portion 33 is provided in the rotation mechanism 50, and is displaceable in conjunction with the key operation by the user. On the other hand, the signal generator 32 is not displaced in conjunction with the key operation. As will be understood from the above description, a distance between the detectable portion 33 and the signal generator 32 changes in conjunction with the key operation by the user.

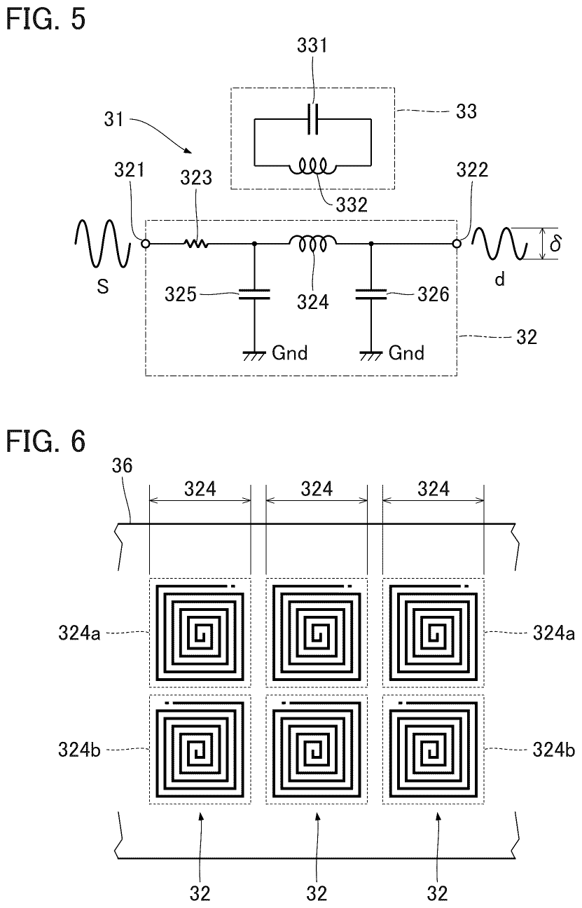

FIG. 5 is a circuit diagram illustrating an electrical configuration of a magnetic sensor 31. The signal generator 32 comprises a resonant circuit that includes an input terminal 321, an output terminal 322, a resistive element 323, a drive coil 324, a capacitive element 325, and a capacitive element 326. One end of the resistive element 323 is connected to the input terminal 321, and the other end of the resistive element 323 is connected to one end of the capacitive element 325 and to one end of the drive coil 324. The other end of the drive coil 324 is connected to the output terminal 322 and one end of the capacitive element 326. The other end of the capacitive element 325 and the other end of the capacitive element 326 are grounded (Gnd).

As illustrated in FIG. 2, each of the signal generators 32 is mounted to a drive board 36. FIG. 6 is a plan view of the drive board 36. The drive board 36 is a wired board that extends in the X-axis direction across the plurality of keys 12. A plurality of signal generators 32 each corresponding to a respective one of the plurality of keys 12 is mounted to the drive board 36. The signal generators 32 are arranged along the X-axis. The drive coil 324 of the signal generator 32 is formed as a conductive pattern on the surface of the drive board 36. In FIG. 6, elements other than the drive coils 324 in the signal generators 32 are omitted for convenience of illustration.

As illustrated in FIG. 6, the drive coil 324 of the signal generator 32 includes a first portion 324a and a second portion 324b. The first portion 324a and the second portion 324b are connected in series to each other to form the drive coil 324. The first portion 324a and the second portion 324b are arranged perpendicular to the X-axis. The first portion 324a and the second portion 324b are formed in spiral patterns in opposing directions to each other. Therefore, a current flows in opposing directions between the first portion 324a and the second portion 324b. That is, magnetic fields opposing each other are generated in the first portion 324a and the second portion 324b. The drive coil 324 may be formed of a plurality of layers of conductive patterns. The drive board 36 is an example of a “wired board.”

As illustrated in FIG. 5, the detectable portion 33 is a resonance circuit that includes a capacitive element 331 and the movable coil 332. One end of the movable coil 332 and one end of the capacitive element 331 are connected to each other, and the other end of the movable coil 332 and the other end of the capacitive element 331 are connected to each other. In the first embodiment, the resonance frequency of the signal generator 32 and the resonance frequency of the detectable portion 33 are set to have equal frequencies. However, the resonance frequency of the signal generator 32 may be different from the resonance frequency of the detectable portion 33.

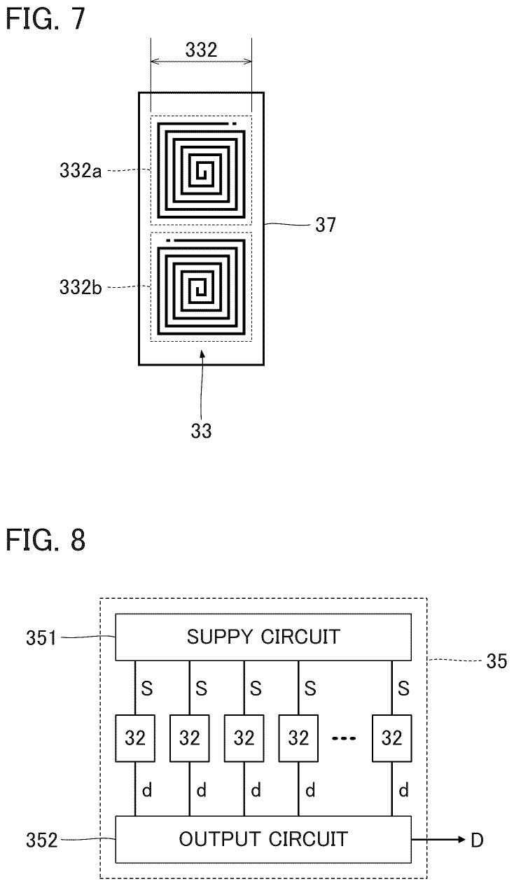

As illustrated in FIG. 2, the detectable portion 33 is mounted to a movable board 37. FIG. 7 is a plan view of the movable board 37. The movable board 37 is a wired board, individually mounted to each of the plurality of keys 12. The movable coil 332 of the detectable portion 33 is formed as a conductive pattern on the surface of the movable board 37. In FIG. 7, elements other than the drive coil 324 in the signal generator 32 are omitted for convenience of illustration.

As illustrated in FIG. 7, the movable coil 332 of each of the detectable portions 33 includes a first portion 332a and a second portion 332b. The first portion 332a and the second portion 332b are connected in series to each other to form the movable coil 332. The first portion 332a and the second portion 332b are arranged perpendicular to the X-axis. The first portion 332a and the second portion 332b are formed in spiral patterns in opposing direction to each other. Therefore, a current flows in opposing directions between the first portion 332a and the second portion 332b. That is, magnetic fields opposing each other are generated in the first portion 332a and the second portion 332b. The drive coil 324 may be formed of a plurality of conductive patterns.

The drive coil 324 and the movable coil 332 are spaced apart and face each other. As described above, since the movable coil 332 is provided in the hammer shank 54, the distance between the drive coil 324 and the movable coil 332 varies depending on the angle of the hammer shank 54. The drive circuit 35 of FIG. 4 generates a detection signal D in accordance with the distance between the drive coil 324 and the movable coil 332. The drive coil 324 is an example of a “second coil,” and the movable coil 332 is an example of a “first coil.”

FIG. 8 is a block diagram illustrating an example configuration of the drive circuit 35. The drive circuit 35 includes a supply circuit 351 and an output circuit 352. The supply circuit 351 supplies a reference signal S to the input terminal 321 of each of the plurality of signal generators 32. For example, the supply circuit 351 is a demultiplexer that supplies the reference signal S to each of the plurality of signal generators 32 in a time-division manner. The reference signal S is a signal with a periodically fluctuating level. For example, a periodic signal of any waveform such as a sine wave or a square wave is used as the reference signal S. The frequency of the reference signal S is sufficiently shorter than the time length of a period during which the reference signal S is supplied to one signal generator 32. Further, the frequency of the reference signal S is set to a frequency substantially equal to the resonance frequency of the signal generator 32 and the detectable portion 33.

The reference signal S is supplied to the drive coil 324 via the input terminal 321 and the resistive element 323. A magnetic field is generated in the drive coil 324 when the reference signal S is supplied. An induced current is generated in the movable coil 332 of the detectable portion 33 by electromagnetic induction of the magnetic field generated in the drive coil 324. That is, a magnetic field in a direction that cancels out a change in the magnetic field of the drive coil 324 is generated in the movable coil 332. The magnetic field generated in the movable coil 332 varies depending on the distance between the drive coil 324 and the movable coil 332. Therefore, a detection signal d, a level of which varies in accordance with a different amplitude 6 depending on the distance between the drive coil 324 and the movable coil 332, is output from the output terminal 322 of the signal generator 32. The detection signal d is a periodic signal, and its level fluctuates at a frequency equivalent to that of the reference signal S. As will be understood from the above description, the signal generator 32 generates the detection signal d corresponding to the distance between the drive coil 324 and the movable coil 332.

The output circuit 352 in FIG. 8 is a multiplexer that generates a detection signal D by arranging, along the time axis, detection signals d sequentially output from the plurality of signal generators 32. Thus, the level of the detection signal D varies over time in accordance with a different amplitude 6 depending on the distance between the drive coil 324 and the movable coil 332. As described above, since the distance between the drive coil 324 and the movable coil 332 depends on the position of the hammer shank 54, the detection signal D is a signal corresponding to the position of each of the plurality of hammer shanks 54. The detection signal D generated by the output circuit 352 is supplied to the control system 21. It is of note that rectification (half-wave rectification or full-wave rectification) and smoothing may be performed on the detection signal D before supplying the detection signal D to the control system 21.

The control system 21 of FIG. 4 generates an audio signal V based on the detection signal D. The control system 21 is realized by a computer system including a control device 211, a storage device 212, an A/D converter 213, and a sound source device 214. It is of note that the control system 21 may be realized not only by a single apparatus but also by a plurality of apparatuses configured separately from each other.

The control device 211 includes one or more processors that control each element of the keyboard musical instrument 100. Specifically, the control device 211 is configured to have one or more types of processors such as a CPU (Central Processing Unit), an SPU (Sound Processing Unit), a DSP (Digital Signal Processor), an FPGA (Field Programmable Gate Array), or an ASIC (Application Specific Integrated Circuit).

The storage device 212 comprises one or more memories that store programs executed by the control device 211 and data used by the control device 211. The storage device 212 comprises a known recording medium, such as a magnetic recording medium or a semiconductor recording medium. It is of note that the storage device 212 may be configured to have a combination of a plurality of types of recording media. A portable recording medium detachable from the keyboard musical instrument 100 or an external recording medium (for example, online storage) with which the keyboard musical instrument 100 can communicate may be used as the storage device 212.

The A/D converter 213 converts a detection signal D supplied from the drive circuit 35 from analog to digital format. The control device 211 determines the position of each of the hammer shanks 54 by analyzing the detection signal D after conversion by the A/D converter 213.

The sound source device 214 generates an audio signal V representing the sound indicated by the control device 211. The control device 211 instructs the sound source device 214 to generate a music sound based on the detection signal D. Therefore, an audio signal V representative of a music sound in accordance with a key operation by the user is generated. It is of note that the control device 211 may realize the function of the sound source device 214 by executing a program stored in the storage device 212.

The sound emitting system 22 of FIG. 1 emits a music sound represented by the audio signal V. For example, one or more speakers or headphones (earphones) worn on the user's head are used as the sound emitting system 22. It is of note that the sound emitting system 22 configured separately from the keyboard musical instrument 100 may be connected to the keyboard musical instrument 100 by wire or wirelessly.

As illustrated in FIG. 2, a holding member 60 is mounted to the rotation mechanism 50. More specifically, the holding member 60 is fixed to the butt 51 of the rotation mechanism 50. The holding member 60 is a structure integrally formed from, for example, a resin material (plastic) or a composite material. The holding member 60 is a holder for holding the movable board 37. As described above, the detectable portion 33 is mounted to the movable board 37. That is, the movable coil 332 of the detectable portion 33 is provided in the holding member 60.

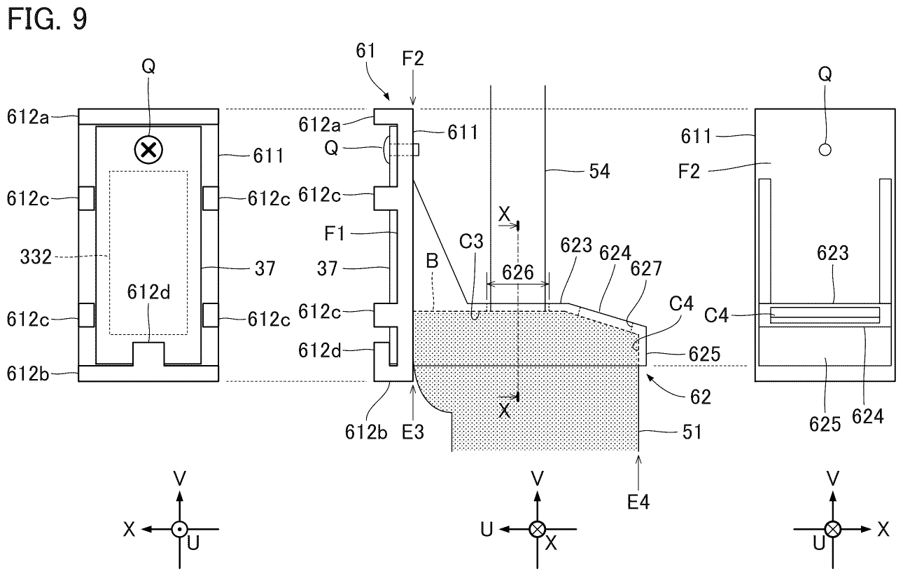

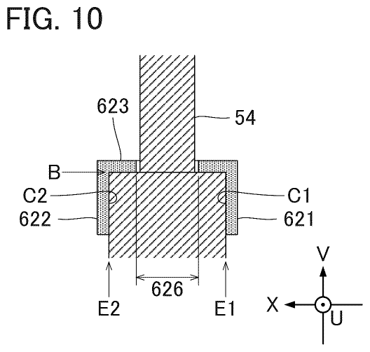

FIG. 9 is an enlarged view of the holding member 60. As a side view in the center of FIG. 9, a butt 51 and a hammer shank 54 are shown together for convenience of illustration. FIG. 10 is a cross-sectional view, taken along X-X line in FIG. 9.

In FIGS. 9 and 10, the U-axis and the V-axis, which are orthogonal to each other, are shown. The U-axis and the V-axis are axes in a plane perpendicular to the X-axis (Y-Z plane). Specifically, the V-axis is an axis parallel to the central axis of the hammer shank 54. The U-axis is an axis orthogonal to the V-axis and the X-axis.

The butt 51 is a structure that includes a mounting surface B and outer wall surfaces E (E1-E4). The mounting surface B is an upper surface facing the direction of the V-axis. That is, the mounting surface B is a flat surface parallel to an X—U plane. The hammer shank 54 is mounted to the mounting surface B. Specifically, the proximal end of the hammer shank 54 is fixed to the mounting surface B. That is, the hammer shank 54 protrudes from the mounting surface B in the V-axis direction.

The outer wall surface E is a side surface that intersects with the mounting surface B. Specifically, the outer wall surface E includes a side surface E1, a side surface E2, a front surface E3, and a rear surface E4, as illustrated in FIGS. 9 and 10. The front surface E3 is a wall surface facing the positive direction of the U-axis. That is, the front surface E3 is a surface that faces the direction in which the butt 51 is displaced when a corresponding one of the plurality of keys 12 is depressed. Specifically, the front surface E3 is continuous to the butt 51 and is an arc-shaped portion in which the butt spring 56 is disposed. The rear surface E4 is a wall surface opposite the front surface E3. The above-described catcher 53 is mounted to the rear surface E4. The side surface E1 and the side surface E2 are wall surfaces that intersect the mounting surface B, the front surface E3, and the rear surface E4. As illustrated in FIG. 10, the front surface E3 and the rear surface E4 are oriented in opposite directions from each other between the side surface E1 and the side surface E2. The side surface E1 is an example of a “first side surface,” and the side surface E2 is an example of a “second side surface.”

As illustrated in FIG. 9, the holding member 60 is a structure in which the holding part 61 and the mounting part 62 are integrally molded. The holding part 61 is a part for holding the movable board 37. Specifically, the holding part 61 includes a base portion 611 and a plurality of edge portions 612(612a, 612b, 612c). The base portion 611 is a plate-shaped portion elongated along the V-axis, and includes a first surface F1 and a second surface F2 that are positioned on opposite sides from each other. The first surface F1 and the second surface F2 are flat surfaces that are parallel to the X-V plane. The plurality of edge portions 612(612a, 612b, 612c) are protrusions that protrude toward the U-axis from the first surface F1 of the base portion 611. The edge portions 612 are spaced apart from each other along the edge of the base portion 611. The movable board 37 is held by the holding part 61, and is surrounded by the plurality of edge portions 612.

The edge portion 612a and the edge portion 612b of the plurality of edge portions 612 are protrusions that protrude along the short side of the base portion 611. The edge portion 612a and the edge portion 612b face the side surfaces constituting the short sides of the movable board 37. The plurality of edge portions 612c are protrusions that protrude along the long side of the base portion 611. The edge portions 612c face the side surfaces constituting the long sides of the movable board 37.

On the edge portion 612b there is an overhang portion 612d that protrudes toward the edge portion 612a to face the front face of the movable board 37. The vicinity of an end portion of the movable board 37, located in the negative direction of the V-axis, is sandwiched between the base portion 611 and the overhang portion 612d, and the vicinity of another end portion of the movable board 37, located in the positive direction of the V-axis, is fixed to the base portion 611 by a fastener Q, such as a screw.

The mounting part 62 is a part for mounting the holding member 60 to the rotation mechanism 50 (namely, the butt 51). The mounting part 62 protrudes from the second surface F2 of the base portion 611 in the negative direction of the U-axis. Specifically, the mounting part 62 includes a side wall portion 621, a side wall portion 622, a top surface portion 623, an inclined portion 624, and a rear surface portion 625, as illustrated in FIGS. 9 and 10. The side wall portion 621 and the side wall portion 622 are wall-shaped portions protruding from the second surface F2 of the base portion 611 in the negative direction of the U-axis. The side wall portion 621 and the side wall portion 622 are spaced apart from and face each other in the X-axis direction.

The top surface portion 623 and the inclined portion 624 are portions that connect the upper edge of the side wall portion 621 and the upper edge of the side wall portion 622. The top surface portion 623 is a plate-shaped portion that is parallel to the X-U plane. A through-hole 626 for passage of the hammer shank 54 is formed in the top surface portion 623. The top surface portion 623 is located between the inclined portion 624 and the base portion 611. The inclined portion 624 is a plate-shaped portion inclined relative to the X-U plane. A rectangular opening 627 is formed in the inclined portion 624. The rear surface portion 625 is a plate-shaped portion that is parallel to the X-V plane, and is continuous with the inclined portion 624. It is of note that the inclined portion 624 may be omitted. That is, a configuration in which the top surface portion 623 and the rear surface portion 625 are continuous is also assumed.

A portion of the butt 51 located in the positive direction of the V-axis is accommodated in a space surrounded by the base portion 611, the side wall portion 621, the side wall portion 622, and the rear surface portion 625. As illustrated in FIG. 10, the inner wall surface C1 of the side wall portion 621 is in contact with the side surface E1 of the butt 51. The inner wall surface C2 of the side wall portion 622 is in contact with the side surface E2 of the butt 51. As illustrated in FIG. 9, the second surface F2 of the base portion 611 is in contact with the front surface E3 of the butt 51. The inner wall surface C4 of the rear surface portion 625 is in contact with the rear surface E4 of the butt 51.

The second surface F2 of the base portion 611, the inner wall surface C1 of the side wall portion 621, the inner wall surface C2 of the side wall portion 622, and the inner wall surface C4 of the rear surface portion 625 are comprehensively expressed as a contact surface C that is in contact with the outer wall surface E of the butt 51. That is, the holding member 60 of the first embodiment includes the contact surface C that is in contact with the outer wall surface E of the butt 51. As described above, the contact surface C includes a portion (second surface F2) that is in contact with the front surface E3 of the butt 51, a portion (inner wall surface C1) that is in contact with the side surface E1, and a portion (inner wall surface C2) that is in contact with the side surface E2. One or more of the second surface F2, the inner wall surface C2, the inner wall surface C3, and the inner wall surface C4 may not be in contact with the outer wall surface E of the butt 51. For example, the inner wall surface C4 of the rear surface portion 625 may face the rear surface E4 of the butt 51 with a space therebetween.

As described above, in the first embodiment, the holding member 60 includes the contact surface C that is in contact with the outer wall surface E of the butt 51. That is, the movement of the holding member 60 in the X-U plane perpendicular to the axial line of the hammer shank 54 is restricted by contact between the contact surface C of the holding member 60 and the outer wall surface E of the butt 51. Therefore, the positional relationship between the movable coil 332 and the drive coil 324 can be set with high accuracy, as compared with a configuration in which the holding member 60 does not include the contact surface C in contact with the outer wall surface E.

In the first embodiment, the contact surface C of the holding member 60 includes a second surface F2 that is in contact with the front surface E3. Therefore, the movement of the holding member 60 in the direction in which the butt 51 is displaced (for example, the direction of the U-axis) can be restricted by the contact between the contact surface C (the second surface F2) of the holding member 60 and the front surface E3 of the butt 51. In the first embodiment, the contact surface C (the inner wall surface C1 and the inner wall surface C2) of the holding member 60 is in contact with the side surface E1 and the side surface E2 of the butt 51. Therefore, the movement of the holding member 60 in the direction in which the side surface E1 or the side surface E2 is facing (for example, the direction of the X-axis) can be restricted by the contact between (i) the side surface E1 and the side surface E2 and (ii) the contact surface C of the holding member 60.

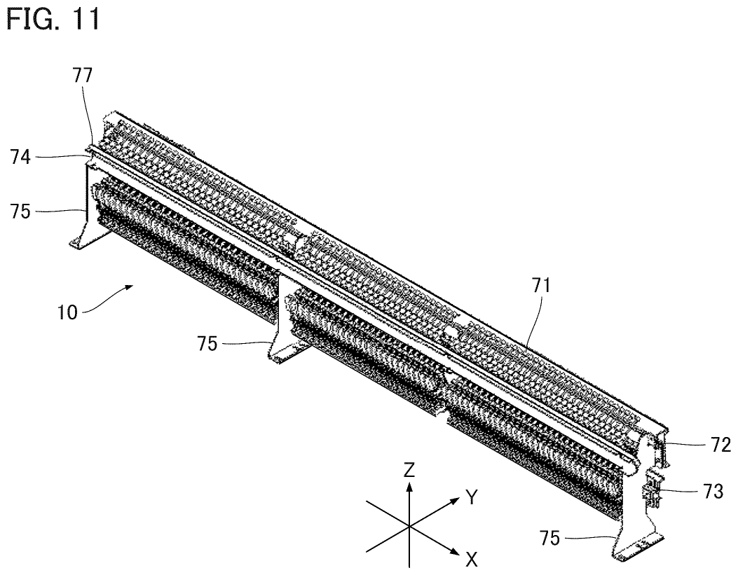

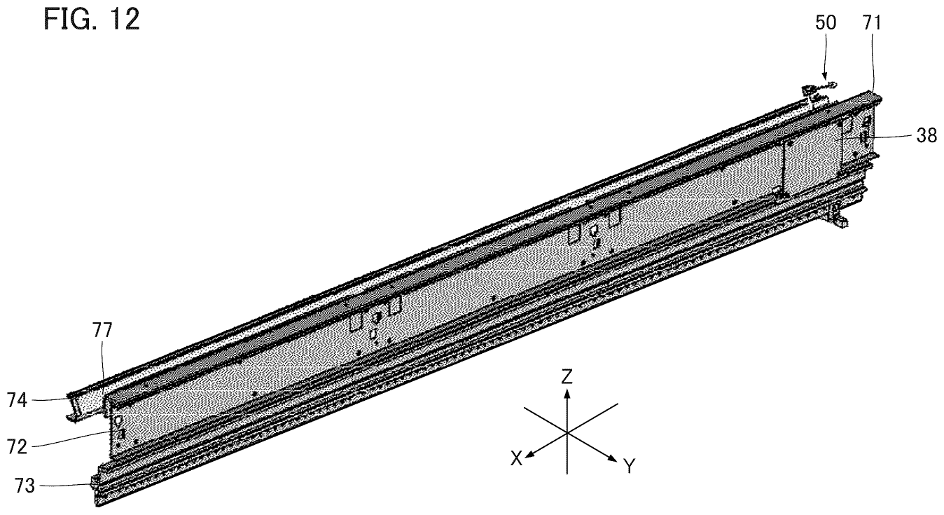

FIGS. 11 and 12 are perspective views of the keyboard unit 10. FIG. 11 shows a plurality of drive mechanisms 14, while FIG. 12 shows only one drive mechanism 14 of the plurality of drive mechanisms 14 as a representative example.

As illustrated in FIGS. 2, 11, and 12, the keyboard unit 10 includes a first support member 71, a second support member 72, a third support member 73, a fourth support member 74, and a plurality of base members 75. It is of note that FIG. 12 does not show the base member 75.

The first support member 71, the second support member 72, the third support member 73, and the fourth support member 74 are formed from, for example, a metal such as stainless steel, and are elongate structures that are continuous across all of the plurality of keys 12 of the keyboard unit 10. That is, the first support member 71, the second support member 72, the third support member 73, and the fourth support member 74 extend along the X-axis to overlay the full width of the keyboard unit 10.

The base members 75 are spaced apart from one another in the direction of the X axis. Each of the base members 75 is an action bracket configured to support the first support member 71, the second support member 72, the third support member 73, and the fourth support member 74. Abase member 75 is made from a metal such as stainless steel.

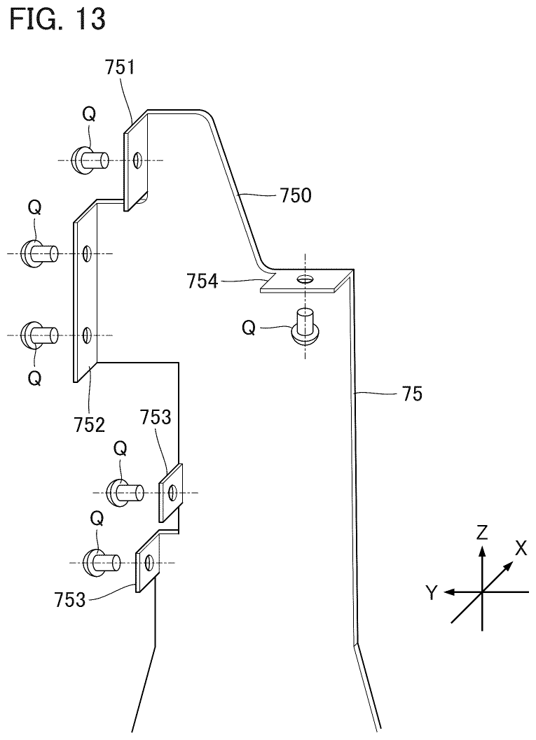

FIG. 13 is a perspective view of a base member 75. The base member 75 is a structure in which a main body portion 750 and a plurality of attachment parts 751 to 754 are integrally formed. For example, the base member 75 is manufactured by pressing a metal plate-like member. The main body portion 750 is a flat plate-shaped portion parallel to the Y-Z plane. Each of the plurality of attachment parts 751 to 754 protrudes from the main body portion 750 in the X-axis direction.

As will be understood from FIGS. 2 and 13, the first support member 71 is fixed to the attachment part 751 by a fastener Q such as a screw. Similarly, the second support member 72 is fixed to the attachment part 752 by a fastener Q. More specifically, the second support member 72 is fixed to the attachment part 752 by way of a plurality of fasteners Q spaced apart from each other in the Z-axis direction. The third support member 73 is fixed to the attachment part 753 by a fastener Q. The fourth support member 74 is fixed to the attachment part 754 by a fastener Q. As exemplified above, the first support member 71, the second support member 72, the third support member 73, and the fourth support member 74 are fixed to the same base member 75.

As illustrated in FIG. 2, the first support member 71 is a bracket that supports the restricting member 76. The restricting member 76 extends in the direction of the X-axis to extend across all the plurality of keys 12 of the keyboard unit 10. The restricting member 76 is formed from a cushioning material such as a low-resilience rubber, a foam material, or a fiber material (e.g., felt). It is of note that the restricting member 76 may be arranged in the X-axis direction.

The restricting member 76 is located in the rotational path of the hammer shank 54. When the hammer shank 54 strikes the restricting member 76 in a course of rotation of the rotation mechanism 50, the restricting member 76 limits displacement of the hammer shank 54. That is, the restricting member 76 is a hammer stopper for limiting the displacement of the hammer shank 54. As will be understood from the above description, in the course of the rotation of the rotation mechanism 50, the respective detectable portion 33 reaches a position at which the restricting member 76 strikes the hammer shank 54. That is, the restricting member 76 serves to define the position of the detectable portion 33 during the key operation. Specifically, the restricting member 76 defines the position of the detectable portion 33 at its closest approach to the signal generator 32.

The second support member 72 is a bracket that supports the drive board 36 and the control board 38. As described above with reference to FIG. 6, the drive board 36 is a wired board on which each of a plurality of signal generators 32 corresponding to different keys 12 is arranged in the X-axis direction. On the other hand, the control board 38 is a wired board to which the drive circuit 35 of FIG. 4 is mounted.

As illustrated in FIG. 2, the second support member 72 is a structure including a main body portion 721, a side wall portion 722, and a side wall portion 723. The main body portion 721 is a flat plate-shaped portion extending in the X-axis direction. The drive board 36 is fixed to the main body portion 721 by a fastener Q such as a screw. Spacers 39 are disposed between the drive board 36 and the main body portion 721. Therefore, the drive board 36 and the main body portion 721 face each other with a predetermined space therebetween. The entire area of the drive board 36 overlaps the main body portion 721 as viewed in the direction of the Y-axis.

The side wall portion 722 protrudes from the upper edge of the main body portion 721 in the positive direction of the Y-axis. On the other hand, the side wall portion 723 protrudes from the lower edge of the main body portion 721 in the positive direction of the Y-axis. That is, the side wall portion 722 and the side wall portion 723 face each other with a space therebetween in the Z-axis direction. The control board 38 is fixed to the side wall portion 722 and the side wall portion 723. As will be understood from the above description, the main body portion 721 of the second support member 72 is positioned between the drive board 36 and the control board 38.

The third support member 73 is a center rail that supports the respective drive mechanisms 14. Specifically, the wippen flange 42 and the butt flange 52 of the drive mechanism 14 are fixed to the third support member 73. The plurality of drive mechanisms 14 corresponding to different ones of the plurality of keys 12 are fixed to the same third support member 73.

The fourth support member 74 is a hammer rail that supports a cushioning member 77. In a course of the rotation mechanism 50 rotating in the direction A2, the hammer shank 54 comes to a stop by striking the cushioning member 77. The cushioning member 77 extends in the direction of the X-axis to extend across all of the plurality of keys 12 of the keyboard unit 10. The cushioning member 77 is formed of a cushioning material such as a low-resilience rubber, a foam material, or a fiber material (e.g., felt).

As described above, in the first embodiment, the first support member 71 that supports the restricting member 76 and the second support member 72 that supports the drive board 36 are fixed to the same base member 75. Therefore, for example, as compared with a configuration in which the first support member 71 and the second support member 72 are fixed to separate members, the positional relationship between the drive coil 324 of the signal generator 32 and the movable coil 332 of the detectable portion 33 can be set with high accuracy.

In the first embodiment, in particular, in addition to the first support member 71 and the second support member 72, the third support member 73 that supports the drive mechanism 14 is also fixed to the base member 75. Therefore, compared with a configuration in which the third support member 73 is fixed to a member separate from the base member 75, an effect is significant in that the positional relationship between the movable coil 332 and the drive coil 324 can be set with high accuracy.

### B: Second Embodiment

A second embodiment will now be described. In the following embodiments, the same reference numerals as those used in the description of the first embodiment are used for elements whose functions are the same as those of the first embodiment, and detailed description thereof will be omitted, as appropriate.

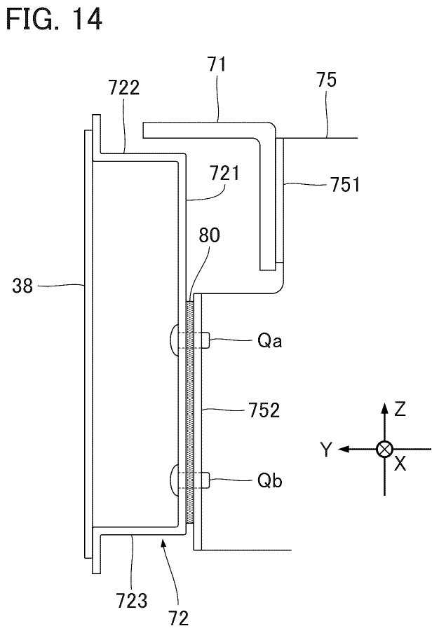

FIG. 14 is an enlarged side view of the vicinity of the attachment part 752 and the second support member 72 of the base member 75. In FIG. 14, illustration of the drive board 36 is omitted for convenience of illustration.

In the second embodiment, an adjustment member 80 is interposed between the second support member 72 and the attachment part 752. The adjustment member 80 is a spacer for adjusting a distance between the second support member 72 and the attachment part 752. The adjustment member 80 is a plate-like member shaped to have a predetermined plate thickness. The position of the second support member 72 in the Y-axis direction is adjusted by varying a number of adjustment members 80 interposed between the second support member 72 and the attachment part 752, including an absence of the adjustment member 80. More specifically, as the number of adjustment members 80 increases, the position of the second support member 72 in the Y-axis direction changes in the positive direction of the Y-axis. It is of note that the distance between the second support member 72 and the base member 75 may be adjusted by selectively using any one of the plurality of types of adjustment members 80 having different plate thicknesses.

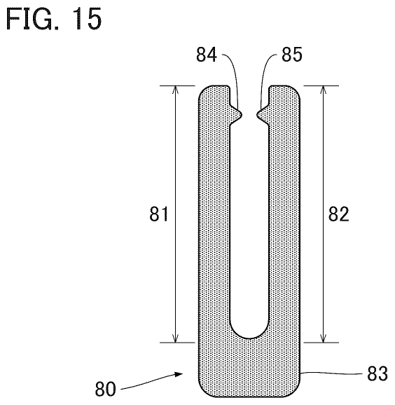

FIG. 15 is a plan view of the adjustment member 80. The adjustment member 80 is a plate-like member including a first arm portion 81, a second arm portion 82, a coupling part 83, a first protrusion 84, and a second protrusion 85. The adjustment member 80 is formed, for example, by punching a plate-like member formed of a resin material or a composite material.

The first arm portion 81 and the second arm portion 82 are arranged side by side at a predetermined distance from each other. The coupling part 83 is a portion that connects the proximal end portion of the first arm portion 81 and the proximal end portion of the second arm portion 82. That is, the first arm portion 81 and the second arm portion 82 extend linearly in the same direction from the respective ends of the coupling part 83. The adjustment member 80 is also expressed as a plate-like member having an elongate annular shape or a rectangular frame shape, with one end open in the longitudinal direction.

The first protrusion 84 protrudes from the distal end portion of the first arm portion 81 toward the second arm portion 82. The second protrusion 85 protrudes from the distal end portion of the second arm portion 82 toward the first arm portion 81. That is, in the distal end portions where the first protrusion 84 and the second protrusion 85 are arranged, the distance between the first arm portion 81 and the second arm portion 82 is reduced in comparison with other portions.

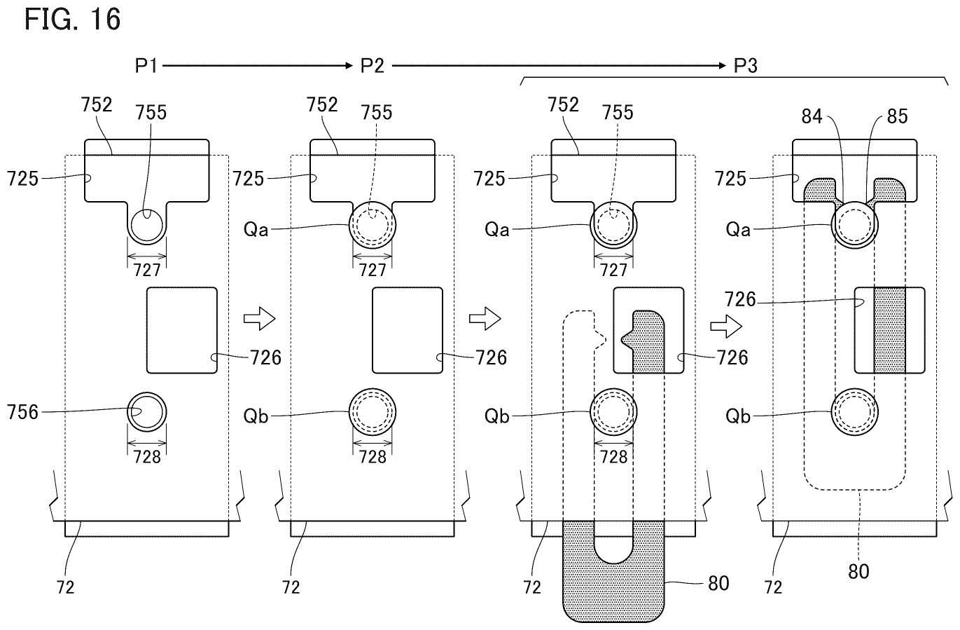

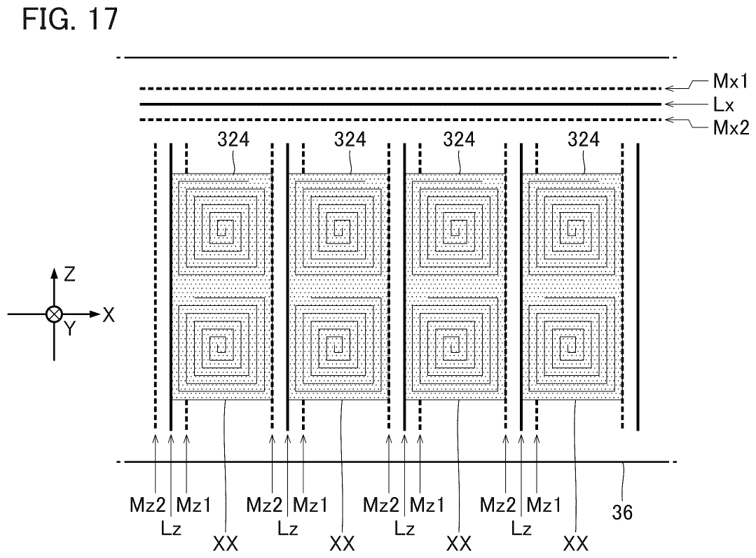

FIG. 16 is an explanatory view of steps for inserting the adjustment member 80 between the attachment part 752 of the base member 75 and the second support member 72. FIG. 16 is a plan view of the second support member 72 viewed in the positive direction of the Y-axis.

First, at Step P1, the second support member 72 is disposed so as to overlap the attachment part 752 of the base member 75. As illustrated in FIG. 16, an opening 725, an opening 726, an attachment hole 727, and an attachment hole 728 are formed in the second support member 72. The opening 725 and the opening 726 are, for example, rectangular through-holes. The attachment hole 727 and the attachment hole 728 are circular through-holes into which the fastener Q is inserted. The opening 725 and the attachment hole 727 are continuous with each other. In addition, a screw hole 755 and a screw hole 756 are formed in the attachment part 752 of the base member 75. The attachment hole 727 overlaps the screw hole 755, and the attachment hole 728 overlaps the screw hole 756.

At Step P2, the fastener Qa and the fastener Qb are temporarily fastened. Specifically, the fastener Qa passes through the attachment hole 727 and is inserted into the screw hole 755, and the fastener Qb passes through the attachment hole 728 and is inserted into the screw hole 756. At this stage, the fastener Qa and the fastener Qb are not fully fastened. Therefore, the distance between the second support member 72 and the attachment part 752 can be changed. For example, the distance between the second support member 72 and the attachment part 752 can be increased, if necessary, to provide sufficient space for insertion of the plurality of adjustment members 80.

At Step P3 after Step P2, the adjustment member 80 is inserted into the gap between the second support member 72 and the attachment part 752. Specifically, the adjustment member 80 is inserted into the gap between the second support member 72 and the attachment part 752 from below, with an orientation in which the first protrusion 84 and the second protrusion 85 are positioned on the upper side.

The distance between the first protrusion 84 and the second protrusion 85 is smaller than the outer diameter of a screw portion, of the fastener Q (Qa, Qb), located between the second support member 72 and the attachment part 752. Accordingly, as the fastener Q passes through the space between the first protrusion 84 and the second protrusion 85, the distance between the first protrusion 84 and the second protrusion 85 is temporarily increased. As illustrated in FIG. 16, the adjustment member 80 is moved upward until the fastener Qa passes through the space between the first protrusion 84 and the second protrusion 85. In a state in which the fastener Qa has passed through the space between the first protrusion 84 and the second protrusion 85, the first protrusion 84 and the second protrusion 85 hook onto the fastener Qa, thereby holing the adjustment member 80 in place (hereinafter, a “holding state”). That is, the first protrusion 84 and the second protrusion 85 prevent the adjustment member 80 from falling. At Step P3, the plurality of adjustment members 80 may be interposed between the second support member 72 and the attachment part 752.

As illustrated in FIG. 16, an opening 725 and an opening 726 are formed to overlap a portion of the adjustment member 80 in the holding state. Specifically, the opening 725 is formed such that the first protrusion 84 and the second protrusion 85 of the adjustment member 80 in the holding state are exposed. Thus, an administrator (e.g., a manufacturer or a person in charge of adjustment) of the keyboard musical instrument 100 can visually confirm through the opening 725 whether the fastener Qa has passed through the space between the first protrusion 84 and the second protrusion 85. Further, the adjustment member 80 can be moved by inserting a tool or a finger into the opening 725 to touch the adjustment member 80.

Further, the opening 726 is formed such that a part of the second arm portion 82 of the adjustment member 80 in the holding state is exposed. Therefore, the administrator of the keyboard musical instrument 100 can visually confirm through the opening 726 the state of the second arm portion 82 (for example, whether the angle is correct). Further, the adjustment member 80 can be moved by inserting a tool or a finger into the opening 726 to touch the adjustment member 80.

As described above, the fastener Qa and the fastener Qb are completely fastened while the adjustment member 80 is held between the second support member 72 and the attachment part 752. That is, the second support member 72 is fixed to the attachment part 752 of the base member 75 by way of a plurality of fasteners Q (Qa, Qb) spaced apart from each other. The adjustment member 80 is interposed between the support member and the base member 75 (attachment part 752) with the fastener Qa and the fastener Qb positioned between the first arm portion 81 and the second arm portion 82.

In the second embodiment, the same effects as those of the first embodiment are attained. In the second embodiment, the adjustment member 80 is interposed between the second support member 72 and the base member 75. As a result of the distance between the second support member 72 and the base member 75 being adjusted by the adjustment member 80, the position of the drive coil 324 in the Y-axis direction is adjusted. Therefore, the positional relationship between the drive coil 324 and the movable coil 332 can be adjusted by varying the plate thickness or the number of the adjustment members 80.

Further, in the second embodiment, the adjustment member 80 can be easily attached and detached in a state in which the second support member 72 and the base member 75 are held together by the plurality of fasteners Q. For example, the adjustment member 80 is mounted by moving the adjustment member 80 such that the plurality of fasteners Q sequentially passes through the space between the first arm portion 81 and the second arm portion 82, and the adjustment member 80 is removed by moving the adjustment member 80 such that the fasteners Q are sequentially disengaged from the space between the first arm portion 81 and the second arm portion 82. Further, since the fasteners Q are disposed at a distance from each other, the angle of the adjustment member 80 is guided such that the longitudinal direction of the adjustment member 80 is along the direction of the arrangement of the plurality of fasteners Q. Therefore, it is possible to reduce a likelihood that the adjustment member 80 is installed at an angle that deviates from a target angle.

In the second embodiment, the first protrusion 84 and the second protrusion 85 facing each other are provided on the adjustment member 80. Since the first protrusion 84 and the second protrusion 85 hook onto the fastener Q, a likelihood of the adjustment member 80 falling from the fastener Q is reduced. That is, even if the adjustment member 80 is not held from the outside, the adjustment member 80 is maintained in a state that it is held by the fastener Q. Therefore, the operations of attaching and detaching the adjustment member 80 can be carried out with ease.

Further, in the second embodiment, the adjustment member 80 can be visually recognized or operated through the opening 725 or the opening 726 on the opposite side of the second support member 72 from the base member 75. Therefore, the operation of attaching and detaching the adjustment member 80 is easier than the configuration in which the opening 725 or the opening 726 is not formed in the second support member 72.

### C: Third Embodiment

FIG. 17 is a schematic view of a drive board 36 according to the third embodiment. As illustrated in FIG. 17, on the front surface of the drive board 36, a set of a reference line Lz, a permissible line Mz1, and a permissible line Mz2 are formed for each of the drive coils 324. For example, on a green surface of the drive board 36, the reference line Lz and the permissible lines Mz (Mz1, Mz2) are formed by applying white paint. The reference line Lz and the permissible lines Mz are straight lines extending along the Z-axis.

The reference line Lz is a solid line along one of the long sides of the drive coil 324. The permissible line Mz1 is a broken line spaced apart from the reference line Lz by a predetermined distance in the positive direction of the X-axis. Similarly, the permissible line Mz2 is a broken line spaced apart from the reference line Lz by a predetermined distance in the negative direction of the X-axis direction. That is, the reference line Lz is located between the permissible line Mz1 and the permissible line Mz2.

Additionally, on the surface of the drive board 36, a reference line Lx, a permissible line Mx1, and a permissible line Mx2 are formed. For example, the reference line Lx and the permissible lines Mx (Mx1, Mx2) are formed by applying white paint on the green surface of the drive board 36. The reference line Lx and the permissible lines Mx are straight lines extending along the X-axis.

The reference line Lx is a solid line along one of the short sides of the respective drive coil 324, and is continuous over the plurality of drive coils 324. The permissible line Mx1 is a broken line spaced apart from the reference line Lx by a predetermined distance in the positive direction of the Z-axis. Similarly, the permissible line Mx2 is a broken line spaced apart from the reference line Lx by a predetermined distance in the negative direction of the Z-axis. That is, the reference line Lx is located between the permissible line Mx1 and the permissible line Mx2.

The respective reference lines (Lz, Lx) and permissible lines (Mz1, Mz2, Mx1, Mx2) are used to adjust the position of the drive board 36 relative to each drive mechanism 14. As described above, each movable board 37 faces the drive board 36. The position of the drive board 36 relative to the respective movable board 37 is adjusted such that the drive coil 324 of the drive board 36 and the movable coil 332 of the movable board 37 face each other.

Specifically, the position of the drive board 36 in the X-axis direction is adjusted such that the long side of the respective movable board 37 is positioned between the permissible line Mz1 and the permissible line Mz2. Ideally, the position of the drive board 36 in the X-axis direction is adjusted such that the long side of the respective movable board 37 overlaps the reference line Lz. As will be understood from the above description, the reference line Lz denotes an ideal position of the long side of the movable board 37. The range between the permissible line Mz1 and the permissible line Mz2 is a permissible error range for the position of the long side of the movable board 37.

Further, the position of the drive board 36 in the Z-axis direction is adjusted such that the short side of the respective movable board 37 is positioned between the permissible line Mx1 and the permissible line Mx2. Ideally, the position of the drive board 36 in the Z-axis direction is adjusted such that the short side of the respective movable board 37 overlaps the reference line Lx. As will be understood from the above description, the reference line Lx denotes an ideal position of the short side of the respective movable board 37. The range between the permissible line Mx1 and the permissible line Mx2 is a permissible error range for the position of the short side of the respective movable board 37.

In the third embodiment, the same effects as those of the first embodiment are attained. Further, in the third embodiment, the positional relation between respective drive coils 324 and respective movable coils 332 can be adjusted with high accuracy by using respective reference lines (Lz, Lx) and respective permissible lines (Mz1, Mz2, Mx1, Mx2) formed on the front face of the drive board 36. The configuration of the second embodiment is similarly applied in the third embodiment.

### D: Modifications

Examples of modifications that can be made to the embodiments described above will now be described. Two or more aspects freely selected from the following examples may be combined as long as they do not contradict each other.

(1) In each of the above-described embodiments, the following configurations are exemplified.

### Configuration A

The first support member 71 and the second support member 72 are fixed to the same base member 75.

### Configuration B

The contact surface C of the holding member 60 is in contact with the outer wall surface E of the butt 51.

### Configuration C

The adjustment member 80 is interposed between the second support member 72 and the base member 75.

Each of Configurations A to C may be independent of the others. Therefore, each of Configurations A to C does not necessarily require the presence of the remaining configurations. That is, Configuration C may be implemented without A or B; Configuration B may be implemented without A or C; and, Configuration A may be implemented without B or C. For example, in a configuration in which Configuration A is employed, a configuration in which the holding member 60 and the butt 51 are not in contact with each other can be conceived. Further, in a configuration in which Configuration B is employed, a configuration in which the first support member 71 and the second support member 72 are fixed to different members can also be conceived. In a configuration in which Configuration C is employed, a configuration in which the first support member 71 and the second support member 72 are fixed to different members or a configuration in which the holding member 60 and the butt 51 are not in contact with each other can also be conceived. In addition, in a configuration in which Configuration A or Configuration C is employed, the rotation of the rotation mechanism 50 may be detected by a sensor other than the magnetic sensor 31. For example, any sensor, such as an optical sensor or a mechanical sensor, is utilized to detect rotation of the rotation mechanism 50.

(2) In each of the above-described embodiments, the holding member 60 and the butt 51 are formed separately. However, the holding member 60 may be formed integrally with the butt 51. For example, an integrally molded article including the holding member 60 and the butt 51 may be molded, for example, by injection molding of a resin material or a composite material. Further, the hammer shank 54 may also be integrally formed with the holding member 60 and the butt 51.

(3) In each of the above-described embodiments, the hammer shank 54 formed separately from the butt 51 is fixed to the butt 51. However, the hammer shank 54 and the butt 51 may be integrally formed. For example, an integrally molded article including the hammer shank 54 and the butt 51 is molded by injection molding of, for example, a resin material or a composite material. In this case, the holding member 60 is mounted to the butt 51 by inserting, into the through-hole 626 of the holding member 60, the rod-shaped hammer shank 54 before the weight portion 55 is mounted, and the weight portion 55 is mounted to in the hammer shank 54 after the mounting of the holding member 60.

(4) In each of the above-described embodiments, the first portion 324a and the second portion 324b of the drive coil 324 are formed in spiral patterns in opposing directions to each other. However, the shape of the drive coil 324 is not limited to the above example. For example, the first portion 324a and the second portion 324b may each be formed in a spiral pattern in the same direction. In addition, the drive coil 324 may be formed of a single spiral-patterned portion. That is, one of the first portion 324a and the second portion 324b may be omitted.

Similarly, the movable coil 332 is not limited to a configuration that includes the first portion 332a and the second portion 332b. For example, the first portion 332a and the second portion 332b may each be formed in a spiral pattern in the same direction. In addition, the movable coil 332 may be constituted of a single spiral-patterned portion. That is, one of the first portion 332a and the second portion 332b may be omitted.

(5) In each of the above-described embodiments, the electronic musical instrument in which the sound source device 214 generates the audio signal V has been exemplified, but the above-described embodiments are similarly applied to a keyboard musical instrument of an acoustic keyboard musical instrument in which a sound source such as a string generates music. In an acoustic keyboard musical instrument, the weight portion 55 in each of the above-described forms is replaced with a strike hammer. For example, each of the above-described embodiments is similarly applied to a keyboard musical instrument having a striking mechanism, such as an automatic performance piano or a mute piano. In the keyboard musical instrument exemplified above, the detection system 30 is used to detect a displacement of a movable member such as a key 12 or a hammer shank 54 (or hammer).

(6) In each of the above-described embodiments, an upright type drive mechanism 14 (action mechanism) has been exemplified, but each of the above-described embodiments is similarly applied to a keyboard musical instrument including a grand piano type drive mechanism. Further, the type of keyboard musical instrument to which the present disclosure is applied is not limited to a piano. For example, each of the above-described embodiments is applicable for various keyboard musical instruments such as a celesta or glockenspiel.

(7) The symbol “n” (n is a natural number) in the present application is used only as a formal and convenient symbol for distinguishing each element in the notation, and has no substantial meaning. Therefore, there is no room for restrictively interpreting a position of each element, an order of manufacture, or the like on the basis of the denotation by the symbol “n.”

### E: Appendices

As examples, the following aspects are derivable from the embodiments above. It is of note that each of the aspects A1 to A2 of Appendix A, the aspects B1 to B3 of Appendix B, and the aspects C1 to C4 of Appendix C illustrated below may be freely combined.

### Appendix A

A keyboard musical instrument according to an aspect (aspect A1) of the present disclosure includes a drive mechanism including a hammer shank configured to be displaceable in conjunction with a key operation; a restricting member configured to be struck by the hammer shank as a result of displacement of the hammer shank; a first support member configured to support the restricting member; a first coil mounted to the drive mechanism; a wired board to which a signal generator including a second coil that generates a magnetic field is mounted, the signal generator being configured to generate a detection signal based on a distance between the first coil and the second coil; a second support member configured to support the wired board; and a base member, in which the first support member and the second support member are fixed to the base member. In the above aspect, the first support member that supports the restricting member and the second support member that supports the wired board are fixed to the same base member. Therefore, for example, as compared with a configuration in which the first support member and the second support portion are fixed to separate members, the positional relationship between the first coil and the second coil can be set with high accuracy.

In an example (aspect A2) of aspect A1, keyboard musical instrument further includes a third support member configured to support the drive mechanism, the third support member being fixed to the base member. In the above aspect, in addition to the first support member and the second support member, the third support member that supports the drive mechanism is also fixed to the base member. Therefore, as compared with the configuration in which the third support member is fixed to a member separate from the base member, the effect is significant in that the positional relationship between the first coil and the second coil can be set with high accuracy.

### Appendix B

A keyboard musical instrument according to an aspect (aspect B1) of the present disclosure includes: a drive mechanism that includes (i) a movable member displaceable in conjunction with a key operation and (ii) a hammer shank mounted to the movable member; a holding member mounted to the movable member; a first coil mounted to the holding member; and a signal generator that includes a second coil for generating a magnetic field and configured to generate a detection signal based on a distance between the first coil and the second coil, in which the movable member includes (i) a mounting surface from which the hammer shank protrudes and (ii) an outer wall surface that intersects the mounting surface, and the holding member includes a contact surface in contact with the outer wall surface. In the above aspect, the holding member includes a contact surface that is in contact with the outer wall surface of the movable member. That is, the movement of the holding member within a plane orthogonal to the axis of the hammer shank is restricted by the contact between the contact surface of the holding member and the outer wall surface of the movable member. Accordingly, the positional relationship between the first coil and the second coil can be set with high accuracy as compared with a configuration in which the holding member does not include the contact surface in contact with the outer wall surface.

In an example (aspect B2) of aspect B1, the outer wall surface includes a front surface that faces in a direction in which the movable member is displaceable by the key operation, and the contact surface includes a portion that is in contact with the front surface. According to the above aspect, the movement of the holding member in the direction in which the movable member is displaceable is restricted by the contact between the front surface of the movable member and the contact surface of the holding member.

In an example (aspect B3) of the aspect B2, the outer wall surface includes a first side surface and a second side surface intersecting the mounting surface and the front surface, the first side surface and the second side surface face in opposite directions, and the contact surface includes a portion that is in contact with the first side surface and a portion that is in contact with the second side surface. According to the above aspect, the contact surface of the holding member is in contact with the first side surface and the second side surface of the movable member. Accordingly, the movement of the holding member in the direction in which the first side surface or the second side surface faces (the lateral direction in which the plurality of keys are arranged) is restricted by the contact between (i) the first side surface and the second side surface and (ii) the contact surface of the holding member.

### Appendix C

A keyboard musical instrument according to an aspect (aspect C1) of the present disclosure includes: a drive mechanism including a hammer shank configured to be displaceable in conjunction with a key operation; a first coil mounted to the drive mechanism; a wired board to which a signal generator including a second coil that generates a magnetic field is mounted, the signal generator being configured to generate a detection signal based on a distance between the first coil and the second coil; a support member configured to support the wired board; and a base member to which the support member is fixed; and an adjustment member that is interposed between the support member and the base member. In the above aspect, the adjustment member is interposed between the support member that supports the wired board and the base member to which the support member is fixed. As a result of the adjustment of the distance between the support member and the base member by the adjustment member, the position of the second coil is adjusted. Therefore, the positional relationship between the first coil and the second coil can be adjusted according to the plate thickness or the number of the adjustment members.

In an example (aspect C2) of aspect C1, the adjustment member is a plate-like member (i.e., a plate member) including (i) a first arm portion and a second arm portion that are spaced apart from each other and arranged side by side, and (ii) a connecting portion that connects a proximal end portion of the first arm portion and a proximal end portion of the second arm portion, in which the supporting member is fixed to the base member by way of a plurality of fasteners disposed at intervals from one another, the plurality of fasteners being located between the first arm portion and the second arm portion. In the above aspect, the adjustment member can be easily attached and detached in a state in which the support member and the base member are held together by a plurality of fasteners. Further, since the plurality of fasteners is disposed at intervals from each other, the adjustment member is guided such that the direction in which the first arm portion and the second arm portion extend is along the direction of the arrangement of the plurality of fasteners. Therefore, it is possible to reduce the likelihood that the adjustment member is installed at an angle that deviates from the target angle.

In an example (aspect C3) of aspect C2, the adjustment member includes a first protrusion that protrudes toward the second arm portion from a distal end portion of the first arm portion, and a second protrusion that protrudes toward the first arm portion from a distal end portion of the second arm portion. In the above aspect, the first protrusion and the second protrusion facing each other are disposed on the adjustment member. Since the first protrusion and the second protrusion are hooked on the fastener, a likelihood of the adjustment member falling from the fastener is reduced. That is, even if the adjustment member is not held from the outside, the adjustment member is held by the fastener. Therefore, the operation of attaching and detaching the adjustment member can be carried out with ease.

In an example (aspect C4) of any of the Aspects C1 to C3, the support member has an opening that overlaps a portion of the adjustment member. In the above aspect, the adjustment member can be visually recognized or operated through the opening on the opposite side of the support member from the fastener. Therefore, the operation of attaching and detaching the adjustment member can be carried out with greater ease than in the configuration in which the opening is not formed in the support member.

### DESCRIPTION OF REFERENCE SIGNS

100 . . . keyboard musical instrument, 11 . . . balance pin, 12 . . . keys, 13 . . . capstan, 14 . . . drive mechanism, 21 . . . control system, 211 . . . control device, 212 . . . storage device, 213 . . . A/D converter, 214 . . . sound source device, 22 . . . sound emitting system, 30 . . . detection system, 31 . . . magnetic sensor, 32 . . . signal generator, 324 . . . drive coil, 33 . . . detectable portion, 332 . . . movable coil, 35 . . . drive circuit, 351 . . . supply circuit, 352 . . . output circuit, 36 . . . drive board, 37 . . . movable board, 38 . . . control board, 39 . . . spacer, 40 . . . transmission mechanism, 41 . . . wippen, 42 . . . wippen flange, 43 . . . jack, 44 . . . jack flange, 45 . . . back check, 50 . . . rotation mechanism, 51 . . . butt, 52 . . . butt flange, 53 . . . catcher, 54 . . . hammer shank, 55 . . . weight portion, 60 . . . holding member, 61 . . . holding part, 62 . . . mounting part, 71 . . . first support member, 72 . . . second support member, 73 . . . third support member, 74 . . . fourth support member, 75 . . . base member, 750 . . . main body portion, 751, 752, 753, 754 . . . attachment part, 76 . . . restricting member, 77 . . . cushioning member, 80 . . . adjustment member, 81 . . . first arm portion, 82 . . . second arm portion, 83 . . . coupling part, 84 . . . first protrusion, 85 . . . second protrusion.

What is claimed is:

1. A keyboard musical instrument comprising:
a drive mechanism including a hammer shank configured to be displaceable in conjunction with a key operation;
a restricting member configured to be struck by the hammer shank as a result of displacement of the hammer shank;
a first support member configured to support the restricting member;
a first coil mounted to the drive mechanism;
a wired board;
a signal generator, including a second coil that generates a magnetic field, mounted to the wired board, wherein the signal generator is configured to generate a detection signal based on a distance between the first coil and the second coil;
a second support member configured to support the wired board; and
a base member,
wherein the first support member and the second support member are fixed to the base member.

2. The keyboard musical instrument according to claim 1, further comprising:
a third support member configured to support the drive mechanism,
wherein the third support member is fixed to the base member.

3. The keyboard musical instrument according to claim 1, further comprising:
a holding member configured to hold the first coil,
wherein the drive mechanism includes a movable member that displaces in conjunction with the key operation,
wherein the movable member comprises:
a mounting surface from which the hammer shank protrudes; and
an outer wall surface that intersects the mounting surface,
wherein the holding member includes a contact surface and is mounted to the movable member, with the contact surface in contact with the outer wall surface.

4. The keyboard musical instrument according to claim 3, wherein:
the outer wall surface includes a front surface that faces in a direction in which the movable member is displaceable by the key operation, and
the contact surface includes a portion that is in contact with the front surface.

5. The keyboard musical instrument according to claim 4, wherein:
the outer wall surface includes a first side surface and a second side surface that intersect the mounting surface and the front surface,
the first side surface and the second side surface face in opposite directions to each other, and
the contact surface includes a first portion that is in contact with the first side surface and a second portion that is in contact with the second side surface.

6. The keyboard musical instrument according to claim 1, further comprising an adjustment member interposed between the second support member and the base member.

7. The keyboard musical instrument according to claim 6, wherein:
the adjustment member includes:
a first arm portion and a second arm portion that are spaced apart from each other and arranged side by side; and
a connecting portion connecting a proximal end portion of the first arm portion and a proximal end portion of the second arm portion,
the second support member is fixed to the base member with fasteners disposed at intervals from each other, and
the fasteners are located between the first arm portion and the second arm portion.

8. The keyboard musical instrument according to claim 7,
wherein the adjustment member further includes:
a first protrusion that protrudes toward the second arm portion from a distal tip end portion of the first arm portion, and
a second protrusion that protrudes toward the first arm portion from a distal tip end portion of the second arm portion.

9. The keyboard musical instrument according to claim 6, wherein the second support member has an opening that overlaps a portion of the adjustment member.
